(19) United States
(12) Patent Application Publication
(10) Pub. No.: US 2014/0334178 A1
(43) Pub. Date: Nov. 13, 2014

(54) CAR NAMEPLATE WITH A BACKLIGHT

(71) Applicant: Aleksandr Alekseevich Zharov, Moscow (RU)

(72) Inventor: Aleksandr Alekseevich Zharov, Moscow (RU)

(21) Appl. No.: 14/365,210

(22) PCT Filed: Sep. 4, 2012
(86) PCT No.: PCT/RU2012/000722

§ 371 Date: Jun. 13, 2014

(30) Foreign Application Priority Data
Dec. 13, 2011 (RU) 2011150805

(51) Int. Cl. B60Q 1/56; F21S 4/00

(52) U.S. Cl. CPC B60Q 1/56; F21S 4/003
USPC 362/549

(57) ABSTRACT

The invention relates to decorative elements for a car. The aim of the proposed invention is to increase the effectiveness of illumination. The invention is realized as follows. A basic element with an external surface and with a first internal surface, a translucent element with a second internal surface and with a connecting surface, and light sources are manufactured, as is an attachment means, if required. A groove is formed in the translucent element on the side of the second internal surface. The light sources are arranged in the groove formed in the translucent element. The translucent element is connected by the second internal surface to the first internal surface, for example, with the aid of an adhesive substance, or by any other method suitable for this field.

### FIELD OF THE INVENTION

This invention relates to decorative elements for cars and other vehicles.

### BACKGROUND OF THE INVENTION

The closest prior art to the present invention is an illuminated nameplate (“Drive2”). Therein, an illuminated nameplate consists of an opaque nameplate, diode strip, clear insert, and fastenings. The nameplate has a depression in which the diode strip is placed. On the diode strip side, the nameplate is connected to the clear insert. On the opposite side from the connection with the nameplate, the clear insert is provided with fastenings. The fastenings serve to connect the illuminated nameplate to the surface of the vehicle.

One shortcoming of the noted prior art is low light efficiency due to the location of the diode strip in the depression in the nameplate and absorption of the light radiation by the material of the opaque nameplate.

There exists a need to increase the light efficiency of such nameplates. The present invention addresses this need.

### SUMMARY OF THE INVENTION

Disclosed herein is an illuminated vehicle nameplate, comprising a main element having opposite placement of an outer surface and a first inner surface, a clear element having opposite placement of a second inner surface and a connecting surface, and a light source comprising an LED strip located between the main element and the connecting surface. The main element is made of an opaque material, and the main element's first inner surface is connected to the second inner surface of the clear element.

In some aspects, the light source is located in a channel made along the second inner surface of the clear element.

In some aspects, the clear element is a translucent element.

### BRIEF DESCRIPTION OF THE DRAWINGS

FIG. 1 shows an example device, as disclosed herein, with a partial cross sectional view.

### DETAILED DESCRIPTION OF THE PREFERRED EMBODIMENT

The present invention comprises an illuminated vehicle nameplate having a main element with opposite locations of an outer surface and a first inner surface, a clear element with opposite locations of a second inner surface and a connecting surface, a light source, the main element made of clear material, the main element of the first inner surface connected with the second inner surface of the clear element, the light source being made in the form of an LED strip and located between the main element and the connecting surface, and a channel being made in the clear element on the side of the second inner surface and the light source being located in the given channel.

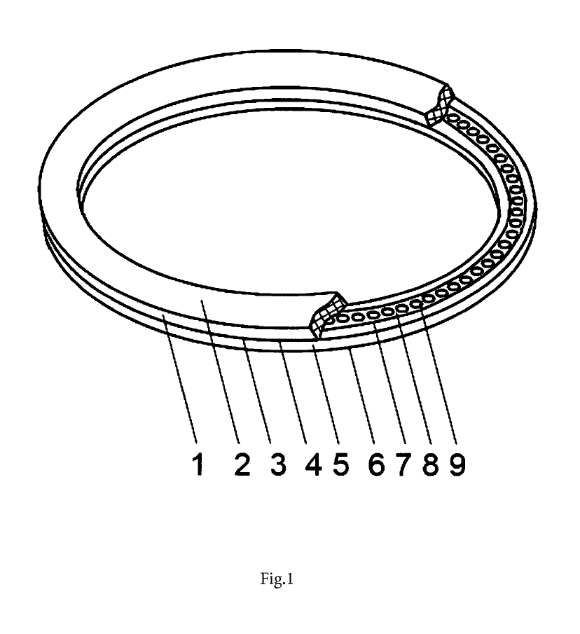

The FIGURE (FIG. 1) shows: main element 1, outer surface 2, first inner surface 3, second inner surface 4, clear (or translucent) element 5, connecting surface 6, channel 7, strip 8, and light source 9.

The main features of the device consist of the main element 1, clear element 5, light source 9, and fastening.

The nameplate constitutes a decorative element that may reproduce the form of any letter or figure or the contour of any figure. The nameplate consists of main element 1, clear element 5, and light sources 9.

Main element 1 may reproduce the form of any letter or figure or the contour of any figure. Main element 1 is opaque, i.e., not translucent. Main element 1 is made of any firm material, such as any plastic or metal. Main element 1 is supplied with an outer surface 2 and a first inner surface 3, the outer surface 2 and first inner surface 3 being located opposite each other, i.e., with opposite sides of main element 1 in relation to each other. The distance between the outer surface 2 and first inner surface 3 is several times less than the size of first inner surface 3 and outer surface 2. The main element 1, in a particular case, may comprise an outer surface 2 and first inner surface 3, each surface comprising one part or several parts, such as a combination of strips located in a specific relationship to one another to form the requisite symbol. Moreover, in a particular case, the outer surface 2 and first inner surface 3 are made in a similar form and are located similarly. Outer surface 2 is turned to the outside of the device, the opposite side from the clear element 5. The first inner surface 3 is turned to clear element 5.

Clear element 5 is flat, in the form of a figure similar to main element 1. Clear element 5 is supplied with a second inner surface 4 and a connecting surface 6. Moreover, the connecting surface 6 and second inner surface 4 are located opposite each other. The distance between the second inner surface 4 and connecting surface 6 is several times less than the size of the second inner surface 4 and the connecting surface 6. The clear element 5, in a particular case, may comprise a second inner surface 4 and connecting surface 6, comprising a complete part or several parts. The form of the second inner surface 4 and connecting surface 6 duplicates the first inner surface 3. The clear element 5 is connected by the second inner surface 4 with the first inner surface 3. The connecting surface 6 is made in such a way as to ensure the possibility of connecting the device to the body of the vehicle, by means of the fastenings, for instance. The clear element 5 is made of clear material, i.e., of translucent material. A channel 7 is made in clear element 5 on the side of the second inner surface 4.

The channel 7 consists of an elongated depression made to provide for the possibility of locating therein light sources 9. The channel 7 is made of the same parts as those making up the clear element 5 or along its perimeter if the clear element 5 is made complete.

The fastening is made to provide for connection of the device to the body of the vehicle. The fastening may consist of an adhesive substance applied to a connecting surface 6 or any other fixative applicable in the given sphere.

A light source 9 is made in the form of an LED strip. In this application, an LED strip is understood as light-emitting diodes located at a certain distance from one another with the possibility of being attached to an electricity source and connected with one another by a fine, flexible, elongated element several times longer than its thickness, such as a tape, thread or several threads or a pipe or wire or any other element with a similar form. The thickness and width of the LED strip are such as to allow for it to be placed in the channel 7.

The invention may be realized as follows. The main element 1 is made with an outer surface 2 and a first inner surface 3, a clear element 5 with a second inner surface 4 and a connecting surface 6, and a light source 9. Also, if necessary, the fastening is made. A channel 7 is made in the clear element 5 on the second inner surface 4. Light sources 9 are placed in a channel 7 made in the clear element 5. The clear element 5 is coupled to the main element 1 by a connection between the second inner surface 4 and the first inner surface 3, for instance, by using an adhesive substance or any other fixative applicable in the given sphere.

The connecting surface 6 of the device is connected to the vehicle body by means of a fastening. The wires from the light sources 9 are connected to the vehicle's dashboard power supply. The outer surface 2 is turned away from the vehicle body. When the dashboard power supply is switched on, the light sources 9 light up. The light emitted by the light sources 9 does not pass through the material of the main element 1, which is opaque, i.e., the light is absorbed thereby. At the same time, owing to the location of the light sources 9 in the channel 7, the angle of emitted light absorbed by the main element 1 is reduced in comparison with the prior art. The light emitted by the light sources 9 passes through the clear element 5 and illuminates the perimeter of the device. It should be noted that the emitted light may be of any color. The given possibility may be provided by making light sources 9 of a single or several colors and a colorless clear element 5, or by making the light sources 9 colorless and the clear element 5 of any hue.

The fact that the device is made up of an opaque main element, a clear element, and a light source thus ensures higher light efficiency through location of the light source in a channel made in the clear element.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. An illuminated vehicle nameplate, comprising:
a main element with opposite placement of an outer surface and a first inner surface,
a clear element with opposite placement of a second inner surface and a connecting surface,
and a light source comprising an LED strip located between the main element and the connecting surface,
wherein the main element is made of an opaque material,
and wherein the main element's first inner surface is connected to the second inner surface of the clear element.

2. The nameplate of claim 1, wherein the light source is located in a channel made along the second inner surface of the clear element.

3. The nameplate of claim 2, wherein the clear element comprises a translucent material.
